(19) United States
(12) Patent Application Publication
(10) Pub. No.: US 2009/0307625 A1
(43) Pub. Date: Dec. 10, 2009

(54) METHOD, DEVICE, DATA CARRIER AND COMPUTER PROGRAM PRODUCT FOR REPRESENTING DATA IN A USER INTERFACE

(75) Inventor: Ruben Daniels, BL Almere (NL)

Correspondence Address: BROOKS KUSHMAN P.C., 1000 TOWN CENTER, TWENTY-SECOND FLOOR, SOUTHFIELD, MI, 48075, US

(73) Assignee: Javeline B.V., BL Almere (NL)

(21) Appl. No.: 12/162,248

(22) PCT Filed: Jan. 25, 2007
(86) PCT No.: PCT/NL07/00025

§ 371 Date: Oct. 16, 2008

(30) Foreign Application Priority Data
Jan. 25, 2006 (NL) 1031006

(51) Int. Cl. G06F 3/048

(52) U.S. Cl. 715/769; 715/764

(57) ABSTRACT

The present invention relates to a method for representing data in a user interface, comprising steps for: determining at least one data set with a tree structure for binding thereof to at least one element of the user interface, selecting a node from the tree as root node for a binding, establishing a binding to the element of the user interface by means of a binding definition comprising binding rules, rendering at least a part of the element of the user interface on the basis of the binding definition. The invention also relates to a device and a computer program product for performing the method.

The present invention relates to a method for representing data in a user interface. The invention also relates to a device for performing such a method. The invention further relates to a data carrier comprising a computer program for performing the method. The invention further relates to a computer program product for performing such a method.

In the use of computers, data available in the computer are usually displayed on a screen of the computer in a manner which can be read by people. This is then a graphic user interface. A example in which use is made of such a graphic user interface is a program which can display the content of hard discs in systematic manner. A further example of such a computer program is a program for displaying e-mails.

In such programs the screen is substantially divided in generally known manner into three display elements. A sub-window for displaying e-mail folders is herein situated on the left-hand side. On the right-hand side two new windows are situated one above the other, wherein a list of headers of e-mails present in an active folder of the left-hand window are displayed in the upper window. The content of one of the e-mails in the list above is generally also displayed on the right-hand side in the lower sub-window. Other examples of displaying information are of course possible.

For the description of the present invention use is made in this text of the e-mail example outlined above.

A great deal of work is involved for programmers to have such a program function in a manner which is visible to the user. In each implementation for displaying data on a screen it is necessary for program code to be written for loading data and values thereof in the different elements of the graphic user interface which are mutually bound in complex manner. Such programming requires a lot of programming work to construct such an application, and such work must be revised in complex manner every time the program is modified.

In order to improve and/or simplify the existing practice the present invention provides a method for representing data in a user interface, comprising steps for:
determining at least one data set with a tree structure for binding thereof to at least one element of the user interface,
selecting a node from the tree as root node for a binding,
establishing a binding to the element of the user interface by means of a binding definition comprising binding rules,
rendering at least a part of the element of the user interface on the basis of the binding definition.

An advantage of such a method is that a programmer having to write such a program no longer has to take into account how data are loaded into elements of graphic user interfaces or applications. Nor is it necessary to write separate code for changes in elements of a user interface when data change. When in the stated e-mail example a new e-mail for instance comes in from an e-mail server, many operations take place in known user-friendly programs for which in the prior art a relatively large amount of programming work was required to display the user interface.

The events which usually take place are for instance that the folder in which the e-mail arrives is shown by means of a display with the attribute [bold], i.e. in a bold font, instead of by means of a normal display. Following the name of such a folder there is usually also indicated how many unread e-mails are still present in the folder. These changes are displayed in a graphic user interface in the left-hand sub-window. A new, unread e-mail will be displayed in the right-hand sub-window in per se known manner, with a header having a bold font attribute. After a preset event, such as the reading of e-mail, the attribute of the bold font will then be converted to a normal font attribute and the display will have to change accordingly. In prior art display software specific program code must be written in order to realize these displays and changes in display. By applying a method for representing data in a user interface according to the present invention only the above stated steps need be performed, whereafter the display of the user interface can be rendered on the basis of the binding definition.

In a first preferred embodiment according to the present invention the binding rules in such a method are suitable for selecting a part of the data of the data set under the root node and giving a value to a property of at least a part of the user interface on the basis of the selection. An advantage of such a preferred embodiment is that (complex) representation definitions can be formulated and executed by means of the binding rules. Properties of at least parts of the user interface can also be influenced. The representation by means of bold fonts can for instance be envisaged here.

In a further preferred embodiment a binding rule is used to select data on the basis of (sub-)elements within the elements of the graphic user interface by means of an information query, wherein the properties of each of the (sub-)elements are defined by means of other binding rules in the binding definition.

An advantage of such an embodiment is that a multinode element can be used for data binding. A further advantage of the present invention is that, by loading data on the basis of a binding rule, the data management can hereby be controlled such that the whole binding definition can be defined in one file or logical whole. The data management can further be modified and realized on the basis of the query.

A binding rule is preferably applied for the purpose of specifying how data are inserted into a data element.

In a further preferred embodiment data are bound to a user interface element at a position which is defined relative to the set root node. An advantage hereof is that, for the purpose of loading data within an element, no event structure is required for performing the same operation.

A part of the data is preferably defined by means of a selected node which is bound to the user interface. An advantage here is that components of a tree structure can be loaded dynamically, a list of hierarchically ordered e-mail folders can for instance be loaded when a symbol suitable for this purpose is clicked in the, in this case graphic, user interface. It is for instance possible here to envisage the >plus=symbol which is shown in front of a folder symbol in a well-known display of a folder structure. The advantage hereof is that network traffic can for instance be reduced in that, when the tree structure is loaded, only data relating to a relatively high hierarchy in the tree structure are loaded in the first instance for rapid display thereof, whereafter data relating to hierarchically lower elements are loaded automatically or according to the wishes of the user. The user can here also indicate a desired sequence.

In a further preferred embodiment a binding rule determines one or more values on the basis of a conversion function. Such a conversion function can be called by means of a call suitable for this purpose. Such a function can for instance be a callable >Javascript=function. Further options herefor are for instance an XSLT transformation. An advantage hereof is that a great freedom in determining the values for rendering is possible by means of calls to be defined in the binding definition.

In a further embodiment the binding definition of an element of the user interface is formulated separately and can be bound to one or more user interface elements. An advantage hereof is that a so-called library of binding definitions can be drawn up, and these can be re-used in different applications or user interface elements. The programming work is hereby reduced further.

The binding definition preferably also comprises a method of retrieving data. An example hereof is that external data can be called on the basis of definitions in the binding definition.

In a further preferred embodiment according to the present method data are retrieved on the basis of an active selection of a further element of a user interface. The workflow of an application is hereby determined. An advantage hereof is that much programming work becomes unnecessary because the workflow hereby no longer has to be constructed on the basis of events. Event calls no longer need be programmed.

In a method according to the present invention changes in the data are preferably transmitted by means of a predetermined data format to a transmitting unit which then transmits the signal to at least one other client for an update of at least one element of a user interface of the other client.

An advantage hereof is that, by means of a method according to the present invention, different workstations or clients are able to physically display data or give users thereof access thereto in a desired manner. By means of such an embodiment the data can be kept synchronous in different user interfaces of different stations.

In a further preferred embodiment an action tracker is applied to track changes in data. This action tracker receives signals relating to operations of a user from the user interface, whereafter these signals are transmitted to components relating to communication or the updating of the data set. Software which updates or maintains the data set can be envisaged here.

The method preferably further comprises steps for performing undo operations on the tracked changes. Where tracking of the changes in data for the purpose of performing operations for displaying a user interface would require an amount of complex programming work according to the prior art, undo operations can be implemented in simple manner in a method according to the present invention by means of such an action tracker. Due to the construction of such a method and the system such an action tracker can be embodied in simple manner.

The method preferably comprises steps for executing, by means of binding rules, drag-drop operations on the basis of information query steps relating to data which is subjected to the operation. Use is made herein of the binding rules, wherein a drag-drop operation can be implemented on the basis of information queries. An advantage hereof is that all rules relating to data can be set at one location, wherein >events=are unnecessary.

A further preferred embodiment according to the present invention comprises steps for transmitting, on the basis of an action definition, a signal for modifying data in the data set, wherein an action rule comprises an information query for determining whether an action has to be performed. Such action definitions are constructed in analogous manner to binding definitions. Such a function can optionally also be function which is callable somewhere on a computer network such as the internet. Using such action definitions a user can modify information by means of for instance an input by means of for instance a keyboard and/or a mouse, whereafter the display on the screen is changed on the basis thereof.

The method according to the present invention more preferably comprises steps for:
applying N binding definitions on at least one up to a maximum of N information sets, wherein:
a value is determined on the basis of one of the binding definitions by means of a selection from one of the information sets, and this value can be placed in one of the information sets on the basis of a further binding definition; and/or
on the basis of a value in one of the information sets, by means of one of the binding definitions, a selection is determined in a further information set on the basis of a further binding definition.

An advantage of such a method is that it can be applied to bi-directional updates. In one application use is for instance made of a first information set, comprising a list with the twelve Dutch provinces. There is a further second information set, comprising a form with personal data about a person and comprising a field, list or drop-down for the purpose of registering, among other information, the province in which the person lives. A selection in the first set determines a province which can be used in the second set for registering and/or highlighting the correct data of the person in this second information set. Conversely, on the basis of the province data in the form, a check thereof can be performed in the first data set relating to the provinces. An advantage here is that, while the form is being filled in, a real time check of the existence of the input, in this case the name of the province, can be performed in the checking data set. Such a method according to the present invention can also be programmed in simple manner.

In such a method a selection is preferably a multiselect. A number of options can hereby be filled in or selected for the purpose of performing the method with a plurality of options.

A user interface is preferably a graphic user interface on a screen of a computer or workstation. Other user interfaces can also be manipulated on the basis of the present invention.

A further aspect according to the present invention relates to a device for performing a method as specified in the foregoing, comprising:
a memory and a processing unit for performing the method steps, and
a display device for perceptibly displaying the user interface. Such a device provides advantages as described with reference to a method.

A further aspect of the present invention relates to a data carrier comprising a computer program for performing such a method. A further aspect further relates to a computer program product for performing a method according to the present invention.

Further advantages, features and details of the present invention will be further described herein below on the basis of several preferred embodiments and with reference to the accompanying figures, in which:

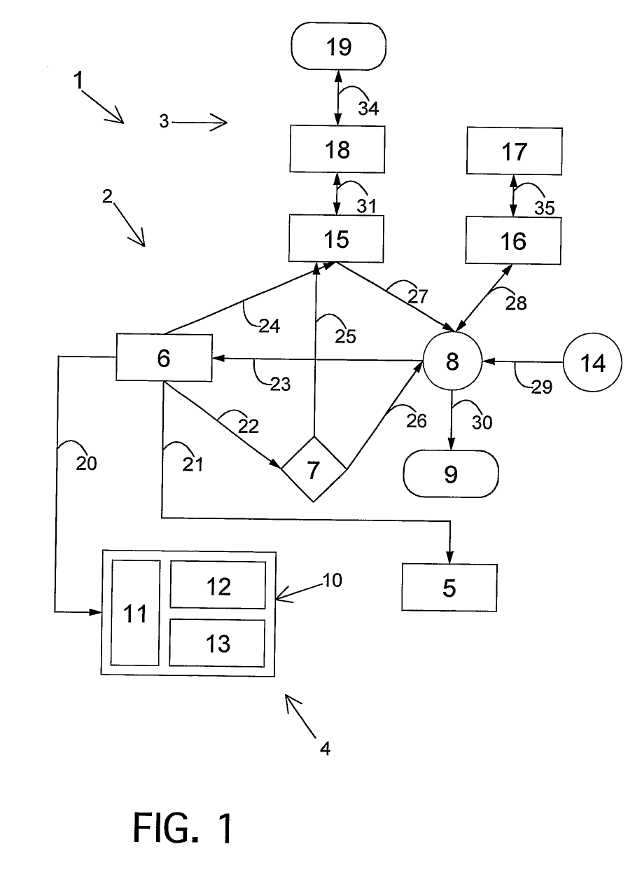

FIG. 1 is a flow diagram of a first preferred embodiment according to the present invention;

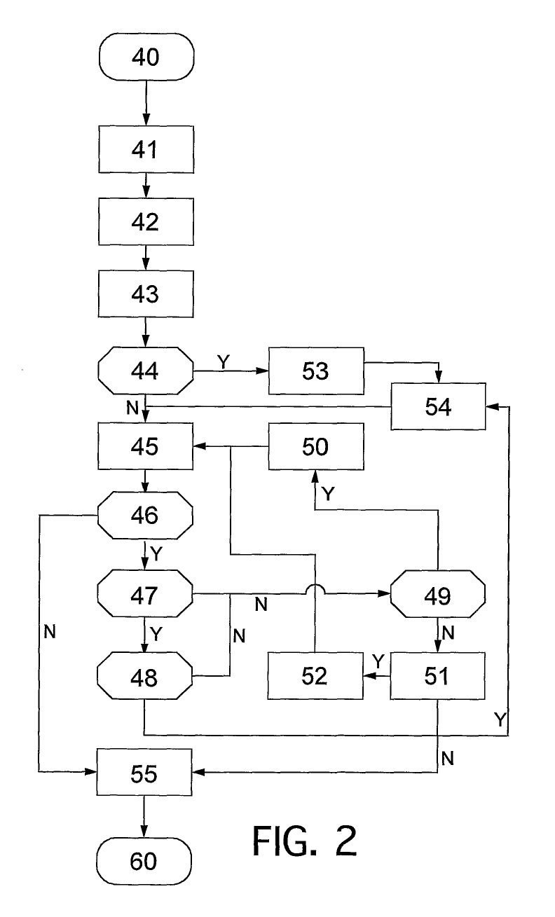

FIG. 2 is a flow diagram of a further preferred embodiment according to the present invention;

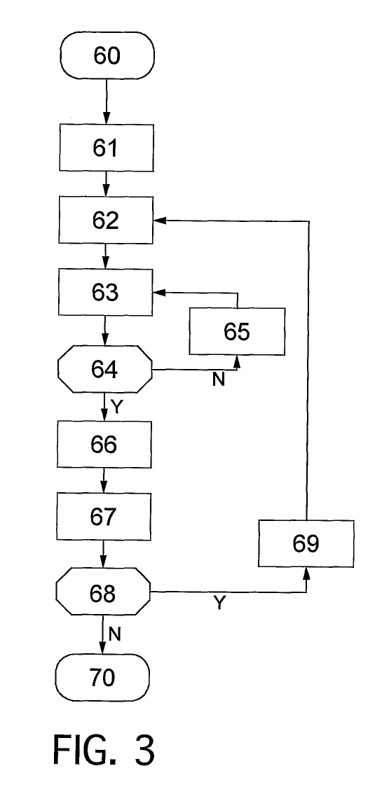

FIG. 3 is a flow diagram of a further preferred embodiment according to the present invention;

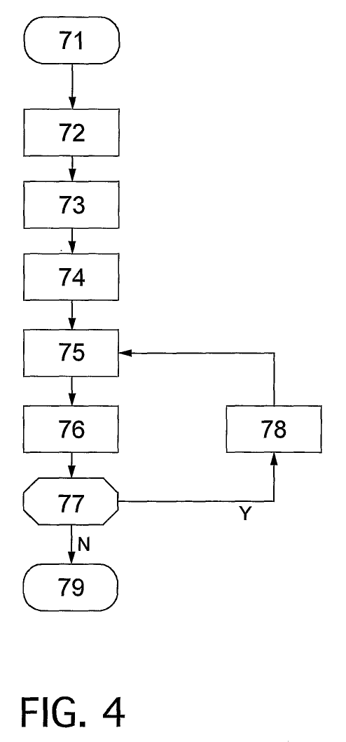

FIG. 4 is a schematic representation of a further preferred embodiment according to the present invention.

FIG. 1 shows a schematic representation of a preferred embodiment of a system for performing a method according to the present invention. FIG. 2 shows a preferred embodiment of an overall method for initiating a user interface making use of a method according to the present invention. FIG. 3 shows a detail of the preferred embodiment of the method of FIG. 2; this figure shows steps which are carried out in step 45 of FIG. 2. In this text the terms user interface element, widget and listener are used in different contexts for the same aspect of the present invention.

After a user interface has been rendered for the first time, the display of the user interface has to be changed when changes occur in the rendered data. The preferred embodiment of FIG. 4 provides steps for this purpose.

A first preferred embodiment according to the present invention relates to a system 1 for performing a method for representing data in a user interface and rendering thereof. The overall system 1 is constructed from a client or workstation 2, a server 3, a screen 4 and input devices 5 such as a mouse and/or keyboard. The client comprises a data storage 9 comprising for instance temporarily stored data from a data storage 19 of the server. Data stored in temporary storage 9 is manipulated by means of database software 8. Changes in the data are further fed to the database software by software 14.

It is possible here to envisage an e-mail program which retrieves data relating to e-mails from a server. Such additions of data are fed to database software 8 by means of changes 29. This software processes them in a manner such that they can be stored in the temporarily stored data 9 by means of input/output 30. The changes are also fed from the database software to a widget 6 which specifically performs the method according to the present invention. Such a widget is a determined amount of program code which provides for the display of data on a screen 4 according to the present invention. The program code of the widget is preferably implemented in so-called classes. When a user interface is started up, the widget serves to construct the user interface on the basis of the data. The widget then serves to display all changes which occur in the temporarily stored data 9 on the screen. Such changes can for instance be the receiving of data, entering of changes by a user of the workstation and the like.

For the purpose of displaying for instance subwindows 11,12 and 13 of graphic user interface 10 on screen 4 a number of widgets 6 exist for each window. This display of sub-windows 11,12 and 13 corresponds with a frequently used display of an e-mail program, wherein the left-hand vertical window shows a folder list, right-hand upper window 12 shows a list of e-mails in one of the folders of window 11, and right-hand lower window 13 shows the content of one of the e-mails of sub-window 12. This is however only an example of a possible display of a graphic user interface in general, and of an e-mail program in particular. Many other variants are possible.

If by means of an input device 5, via input line 21 which is a logical representation thereof, a user initiates a change which requires a change on the screen, this change is fed to the widget which executes changes. The widget will also transmit the change to action tracker 7 by means of a reference 22. This action tracker 7 in turn forwards the changes to database software 8, whereafter the correct data will be stored in the temporarily stored data 9 by means of an input/output 30. Database software 8 will retrieve from the temporary data storage and transmit the desired data to widget 6 via channel 23 so that the widget logic can render the data for suitable display of the data in the UI elements.

Action tracker 7 will further transmit data to a communication means 15 which stores the data via communication 34 in a database storage 19 on a server by means of communication 31 via an API 18.

Database software 8 is further able to transmit the changes to a transmitting unit 17 via a communication means 16 and a change transmitting means 35 for the purpose of transmitting changes in the temporary storage memory 9 to other workstations, so that the modified data, which are for instance originally entered via keyboard 5, can be shown to users of other workstations. The entered changes are rendered by the widget software and transmitted to the screen via communication channel 20.

During initiation of the graphic user interface (FIG. 2, 3) the widget logic can request via channel 24 the loading of data to temporary data storage 9 from the data set 19 on for instance a server.

The method of the widget according to the present invention will be elucidated further on the basis of the flow diagram of FIG. 2 and following.

The method according to the present invention starts in step 40. In step 41 a data set is selected for binding thereof to an element of the graphic user interface (widget) displayed on screen 4. A plurality of elements of the graphic user interface can be displayed on screen 4. The elements can be provided with a plurality of values, such as for instance a number of different folder names. The elements can also be bound to values such as icons, such as icons for folders or other graphic displays which are relevant to the element for displaying. Elements can also be provided with display attributes in order to determine a manner of display, such as for instance displaying text in a normal or in a bold display. A further variant of displays which can be defined by means of attributes is for instance displaying an element as being for instance selected for performing an operation therewith.

In step 42 a binding point is set in the data as the root node for the element of the user interface. Suppose that a file with user data for an e-mail program is used as data set for the method. In such a case the >inbox=folder can be set as root node for an element of the user interface (UI) which displays the list of e-mails.

In step 43 such a UI element is then set as listener (widget) for this root node. Any change which influences the root node and data elements situated thereunder will then be observed by the listener. With reference to FIG. 1 the widget software, which can embody a number of separate widgets within which the UI elements are stored, will herein observe all changes 23.

In step 44 is determined whether the UI element is a UI element comprising a plurality of sub-elements, each with its own individual properties. If it is determined that a UI element is not a multi-node UI element, step 45 continues by means of performing the method of FIG. 3.

If it is determined in step 44 that a UI element is a multi-node UI element, the method is continued in step 53. In step 53 a selection query is executed on the basis of a binding rule in order to select a part of the database therewith. In step 54 a first element of the selected data is chosen for use in step 45 for the purpose of determining the value thereof according to the method of FIG. 3.

In step 45 the value of properties for a UI element or sub-UI element is determined by means of a query. Details of the steps required for this purpose are shown in FIG. 3, which will be described first below for the sake of clarity of description.

In FIG. 3 the method of step 45 of FIG. 2 is started in step 60. In step 61 the first bound properties are consulted. Use is made of binding rules for this purpose. The first of possibly available binding rules is therefore retrieved in step 62. Selection queries and conversion rules for providing a value which must be assigned to a property of a UI element or sub-UI element are available in these binding rules.

As stated above, the binding rules are of the type if . . . then . . . A selection is made on the basis of a query, whereafter a value is determined for the selection if a valid selection has been made. A default method can suffice for determining the value. Suitable program code can also be available for calling in order to determine the value. In step 63 a selection query is executed in order to determine for instance a UI property, such as a caption or an icon.

In step 64 is then determined whether the query produces valid results. If it is determined in step 64 that no valid result is obtained, the subsequent node is consulted in step 65 and step 63 continues by once again executing a selection query.

If it is determined in step 64 that the query produces a valid result, the result is converted in step 66 into a value as indicated in the foregoing. In step 67 the value is then assigned to the property. In step 68 is then determined whether a binding rule for a subsequent property exists. If this is the case, the subsequent property is retrieved, via step 69 for the purpose of getting the first binding rule therefor on the basis thereof, in step 62. If it is determined in step 68 that no binding rule exists for a subsequent property, the method of FIG. 3 is ended in step 70 and continued in step 46 of FIG. 2.

As stated, the method continues in step 46 of FIG. 2. In this step 46 is once again determined whether the UI element is a multi-node element. An example of a node with a non-multi-node element is for instance a slider. An example of a multi-node UI element is an element in which a tree structure can be displayed, such as a folder in an e-mail program. If it is determined in step 46 that the UI element is not a multi-node element, the data for this UI element are complete and the UI element is rendered in step 55.

If it is determined in step 46 that the UI element is a multi-node element, further nodes must be examined and the method continues in step 47. In step 47 is determined whether the present UI element must be able to display a visual representation of a tree structure. If it is determined that this is not the case, the method is continued in step 49, which determines whether a subsequent node exists. If it is determined in step 49 that a subsequent node exists, the subsequent sibling node is consulted in step 50 and the method continues in step 45.

If it is determined in step 49 that no subsequent node exists, it is determined in step 51 whether the UI element must be able to display a tree structure and whether a subsequent parent node which complies with the traverse bind rule of step 53 is present at a higher level of the data structure. The method hereby goes back one level in recursive manner, and the method is continued. If it is determined in step 51 that there is no subsequent node with a higher level, the method is continued in step 55 by rendering the UI element. If the subsequent parent with a higher level is found in step 51, the method continues in step 52 with consulting this subsequent parent and continues with determining the value for display of the UI element in step 45.

Returning to step 47, with the result that it must be possible to display a visual representation of a tree structure in this UI element, the method continues in step 48 with determining whether this node has a child node. If it is determined in step 48 that this is not the case, the method continues in step 49 with determining whether there is another sibling node. In this way a depth first search of the tree structure is always performed as to whether values for display in the user interface have to be determined, and then in lateral and higher direction of the tree. If it is determined in step 48 that the node has a child node, the method is continued in step 54 by means of consulting this node for the purpose of determining the values of the properties of the UI element in step 45. Once a display rendering has been performed in this manner for all nodes of the UI elements in step 55, the method ends in step 60.

FIG. 4 shows schematically a preferred embodiment of a method according to the present invention. When a user interface is displayed on for instance a computer screen, and is therefore filled according to the present invention with the correct data from a child data set, changes in the child data or changes made in a user interface by a user must then be displayed correctly after the change. A preferred method herefor is shown in FIG. 4. The method starts in step 71. In step 72 a part of the data is changed by a process outside the widget of the user interface, such as for instance by means of a process 14 (FIG. 1). Widget 6 is defined by means of the binding rules as a listener for the data relating to this widget. A binding between the listener and the root node is communicated to database software 8.

In step 73 a list of listeners is retrieved on the basis of the changed data. In step 74 a get first listener operation is performed. In step 75 a listener, which is in fact a widget 6 serving to render an element of the user interface, is then informed about the change. In a practical sense the graphic display of the UI element is hereby changed in a manner corresponding with the changes in the child data. In step 76 the display is then rendered on the basis of the change. In step 77 is then determined whether there is a subsequent listener which has to be called on the basis of the change which has occurred in step 72. If this is the case, the subsequent listener is called in step 78 and is informed in step 75 about the change in the data and the change that is therefore also necessary in the graphic display of the UI element to which this relates. After performing of step 76, and if it is determined in step 77 that there is no subsequent element of the graphic user interface, or widget or listener, of which the display has to be changed on the basis of data change in step 72, the method ends in step 79.

According to the above described embodiments, important method steps are performed by widget components 6. These components render a new display of elements of a user interface on the basis of supplied information. A definition of a graphic user interface can hereby be realized in efficient manner. Changes are rendered into a suitable display in a manner initiated by events, without separate user interface definitions having to be created for this purpose. The system will hereby be able to function in a more structured manner and new elements of a graphic user interface, including bindings thereof to child data structures, can hereby be manufactured in advantageous manner.

Changes in the child data which are not initiated by a user, therefore data changes coming from outside, are monitored by means of a binding of widget 6 to the child database software such that, on the basis of the change, the widget carries out a new rendering on the basis of the correct (new or modified) data.

Changes made in the data by the user of the system are fed through action tracker 7 and then updated in the temporarily stored data 9 or in a data set to which this temporary storage relates. An advantage hereof is that it is possible in simple manner to implement that changes can be undone.

An advantage of the user interface being bound directly to the child data in the present invention is that, where in the prior art a programmer had to take into consideration the question of how the interface had to change when the data changed, he/she now only has to take into account which data are displayed as a result of defining the binding definition and the binding rules. The widget is then able to automatically generate a correct rendering on the basis of the definition. The question relating to how data must be loaded in a user interface hereby becomes superfluous. Such an implementation according to the present invention has the advantage that during the design of an application a designer can make use of a separation between data, projection and logic (this is known as the so-called model view controller principle).

Depending on the practical implementation in a final system, the physical level of rendering of the user interface can vary from a rendering to a very low physical level of display to rendering to a graphic engine which further processes the data for display on a screen.

The invention is described in the foregoing on the basis of several practical preferred embodiments. These preferred embodiments do not limit the scope of protection of the present application. The rights sought are defined by the appended claims.

1. Method for representing data in a user interface, comprising steps for:
determining at least one data set with a tree structure for binding thereof to at least one element of the user interface,
selecting a node from the tree as root node for a binding,
establishing a binding to the element of the user interface by means of a binding definition comprising binding rules,
rendering at least a part of the element of the user interface on the basis of the binding definition.

2. Method as claimed in claim 1, wherein the binding rules are suitable for selecting a part of the data of the data set under the root node and giving a value to a property of at least a part of the user interface on the basis of the selection.

3. Method as claimed in claim 1, wherein a binding rule is used to select data on the basis of (sub-)elements within the elements of the graphic user interface by means of an information query, wherein the properties of the (sub-)elements are defined by means of other binding rules in the binding definition.

4. Method as claimed in claim 1, wherein a binding rule is used for the purpose of specifying how data are inserted into a data element.

5. Method as claimed in claim 1, wherein data are bound to a user interface element at a position which is defined relative to the set root node.

6. Method as claimed in claim 3, wherein a part of the data is defined by means of a selected node which is bound to the user interface.

7. Method as claimed in claim 1, wherein one or more values are determined in a binding rule on the basis of a conversion function.

8. Method as claimed in claim 1, wherein a binding definition of an element of the user interface is formulated separately and can be bound to one or more user interface elements.

9. Method as claimed in claim 1, wherein the binding definition also comprises a method of retrieving data.

10. Method as claimed in claim 8, wherein data are retrieved on the basis of an active selection of another user interface element.

11. Method as claimed in claim 1, wherein changes in the data are transmitted by means of a predetermined data format to a transmitting unit which then transmits the signal to at least one other client for an update of at least one element of a user interface of the other client.

12. Method as claimed in claim 1, wherein an action tracker is applied to track changes in the data.

13. Method as claimed in claim 12, comprising steps for performing undo operations on the basis of the tracked changes.

14. Method as claimed in claim 1, comprising steps for executing, by means of rules, drag-drop operations on the basis of information query steps relating to data which is subjected to the operation.

15. Method as claimed in claim 1, comprising steps for transmitting, on the basis of an action definition, a signal for modifying data in the data set, wherein an action rule can comprise an information query for determining whether an action has to be performed.

16. Method as claimed in claim 1, comprising steps for:
applying N binding definitions on at least one up to a maximum of N information sets, wherein:
a value is determined on the basis of one of the binding definitions by means of a selection from one of the information sets, and this value can be placed in one of the information sets on the basis of a further binding definition; and/or
on the basis of a value in one of the information sets, by means of one of the binding definitions, a selection is determined in a further information set on the basis of a further binding definition.

17. Method as claimed in claim 16, wherein a selection is a multi select.

18. Method as claimed in claim 1, wherein the user interface is a graphic user interface on a screen of a computer or workstation.

19. Device for performing a method as claimed in claim 1, comprising:
a memory and a processing unit for performing the method steps, and
a display device for perceptibly displaying the user interface.

20. Data carrier comprising a computer program for performing a method as claimed in claim 1.

21. Computer program product for performing a method as claimed in claim 1.
